(19) United States
(12) Patent Application Publication
(10) Pub. No.: US 2002/0167187 A1
(43) Pub. Date: Nov. 14, 2002

(54) Mounting fastener and assembly

(75) Inventor: Jason T. Murar, Clinton Township, MI (US)

Correspondence Address: Lawrence G. Almeda, Brooks & Kushman P.C., 1000 Town Center, 22nd Floor, Southfield, MI, 48075-1351, US

(73) Assignee: Patent Holding Company, Fraser, MI (US)

(21) Appl. No.: 09/852,492

(22) Filed: May 10, 2001

(51) Int. Cl. B60R 13/02

(52) U.S. Cl. 296/39.1

(57) ABSTRACT

The present invention involves a mounting fastener attachable to a panel member of a vehicle for retention of the panel member to a support structure. The mounting fastener comprises a base member having first and second opposing ends and is substantially planar for attachment to the panel member. The mounting fastener further comprises a biased member having first and second legs respectively extending from the first and second ends. The first and second legs merge together into a substantially parallel relationship at a head. The head has first and second wings respectively extending from the first and second legs toward the base member, wherein each wing has a flap which is twisted with respect to the wing and extends outwardly to a distal edge. The distal edge forms an acute angle with respect to the wing.

### BACKGROUND OF THE INVENTION

1. Field of the Invention

The present invention is related to a mounting fastener and assembly of a vehicle panel member for retention of the vehicle panel member to a vehicle support structure.

2. Background Art

Technology for vehicle air bag deployment continues to be improved. Currently, air bag deployment assemblies allow for an air bag to be deployed from various members, e.g., a front panel or a side panel member, within a vehicle compartment. A panel member which is attached to a vehicle support structure has a door or hinged portion through which an air bag may be deployed during impact of the vehicle. Typically, the panel member in which a deployable air bag is housed remains attached to the support structure upon deployment of the air bag. Generally, a substantial amount of force is used to deploy the air bag during a vehicle impact situation. In many cases, the panel member is attached to the vehicle support structure by fasteners to hold the panel member to the support structures during deployment of the air bag.

Although current fasteners provide adequate retention of the panel members onto respective vehicle support structures, the current fasteners can be improved. As technology improves, greater force may be used to deploy an air bag from a panel member. Thus, what is needed is a fastener which will retain the panel member onto the support structure at greater forces, thereby allowing proper deployment of an air bag during a vehicle impact situation.

### SUMMARY OF THE INVENTION

It is an object of the present invention to provide a mounting fastener for improved retention of a panel member to a support structure of a vehicle during deployment of an air bag from the panel member. This is achieved by configuring the mounting fastener to be insertable in a hole of a support structure, wherein the mounting fastener has edges which engage an inside surface of the support structure of the vehicle. The edges are configured to engage, with improved leverage, onto the inside surface of the support structure such that the mounting fastener is retained in the hole of the support structure in an improved fashion to thereby anchor the panel member onto the support structure.

It is another object of the present invention to provide an improved mounting fastener attachable to a panel member of a vehicle for retention of the panel member to a support structure. The support structure has inside and outside surfaces and a mounting hole formed through the support structure. The mounting fastener comprises a base member and a biased member extending from the base member. The base member has first and second opposing ends, wherein the base member is substantially planar for attachment to the panel member. The biased member has first and second legs respectively extending from the first and second ends and merging together into a substantially parallel relationship at a head. The head has first and second wings which respectively extend from the first and second legs toward the base member. Each wing has a flap which is twisted with respect to the wing and extends outwardly to a distal edge. The distal edge forms an acute angle with respect to the wing and is configured to engage the inside surface of the support structure when the head of the biased member is inserted through the mounting hole for attachment of the panel member to the support structure.

In another embodiment, the present invention provides an improved mounting fastener, as described above, attached to a panel member of a vehicle for retention of the panel member to a support structure. In this embodiment, each wing extends to a flange which projects outwardly therefrom. The flange is configured to engage the outside surface of the support structure when the distal edge engages the inside surface of the support structure.

In yet another embodiment, the present invention provides for an improved mounting assembly including the mounting fastener described above for retention of a panel member to a support structure in a vehicle. The panel member has a panel aperture formed therethrough and an inner side to which an air bag is disposed for deployment during an impact of the vehicle. The inner side is disposed adjacent the support structure having inside and outside surfaces and a mounting hole formed through the support structure. The mounting assembly comprises a first mounting fastener as described above, wherein the base member has a base aperture in alignment with the mounting hole of the panel member when the first mounting fastener is attached to the base member. Moreover, the assembly further comprises a second mounting fastener disposed through the panel aperture and the base aperture to attach the first mounting fastener to the inner side of the panel member.

Other objects, features, and advantages of the present invention will be apparent from the ensuing description in conjunction with the accompanying drawings.

### BRIEF DESCRIPTION OF THE DRAWINGS

FIG. 1a is an environmental view of a mounting assembly of a panel member installed within a vehicle in accordance with the present invention;

FIG. 1b is an environmental view of a mounting fastener of the panel member in FIG. 1a;

FIG. 2 is a perspective view of the mounting fastener shown in FIG. 1b;

FIG. 3 is a side view of the mounting fastener of FIG. 2 in accordance with the present invention;

FIG. 4 is a side view of the mounting fastener in FIG. 3 rotated 90°;

FIG. 5 is a top view of the mounting fastener shown in FIG. 2; and

FIG. 6 is a cross sectional view of the mounting fastener attaching the panel member to a support structure.

### DETAILED DESCRIPTION OF THE PREFERRED EMBODIMENTS

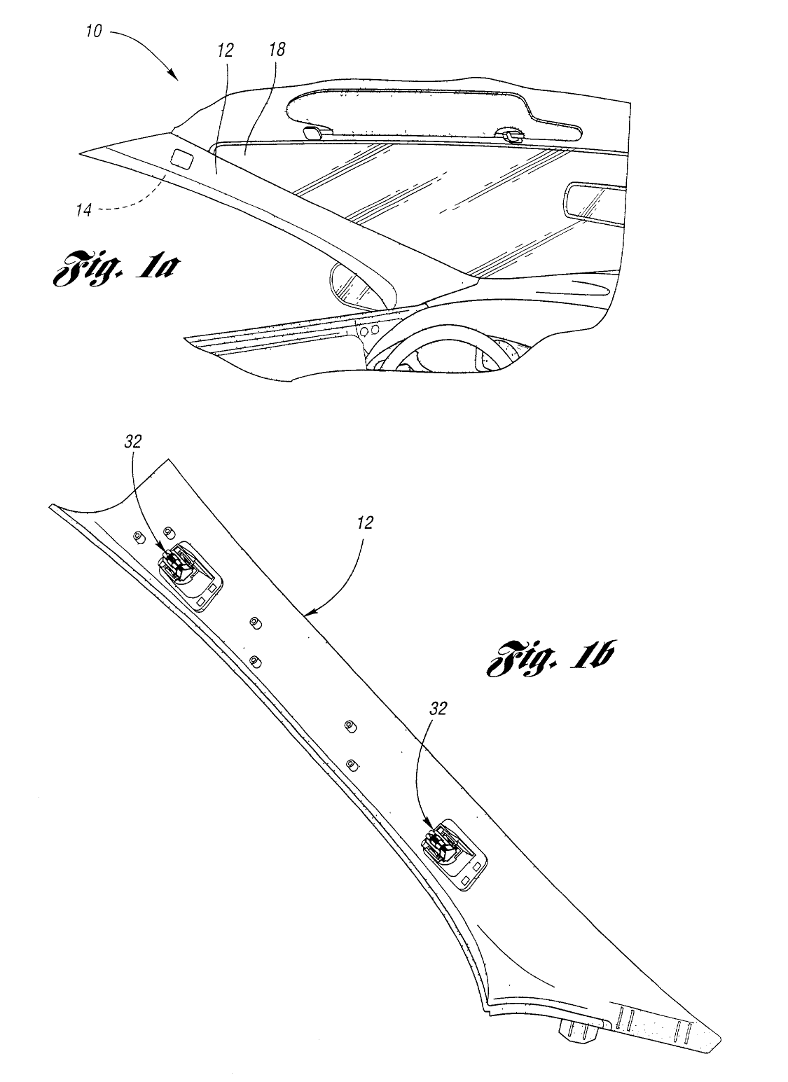

FIG. 1a illustrates vehicle 10 in which a panel member 12 is mounted to compartment support structure 14 in order to house an air bag (not shown) for deployment into vehicle compartment 18 during an impact of vehicle 10. Panel member 12 is mounted to support structure 14 by way of improved mounting fasteners 32 as shown in Figure lb. As described in greater detail below, mounting fastener 32 inserts through a mounting hole of support structure 14 and engages both an inside surface and an outside surface of support structure 14. Upon vehicle impact, an air bag housed within panel member 12 may be deployed into a vehicle compartment while panel member 12 remains fully intact onto support structure 14 without disconnection or disengagement therefrom. Thus, mounting fastener 32 provides improved retention of panel member 12 to support structure 14 during deployment of air bag 16 into vehicle compartment 18.

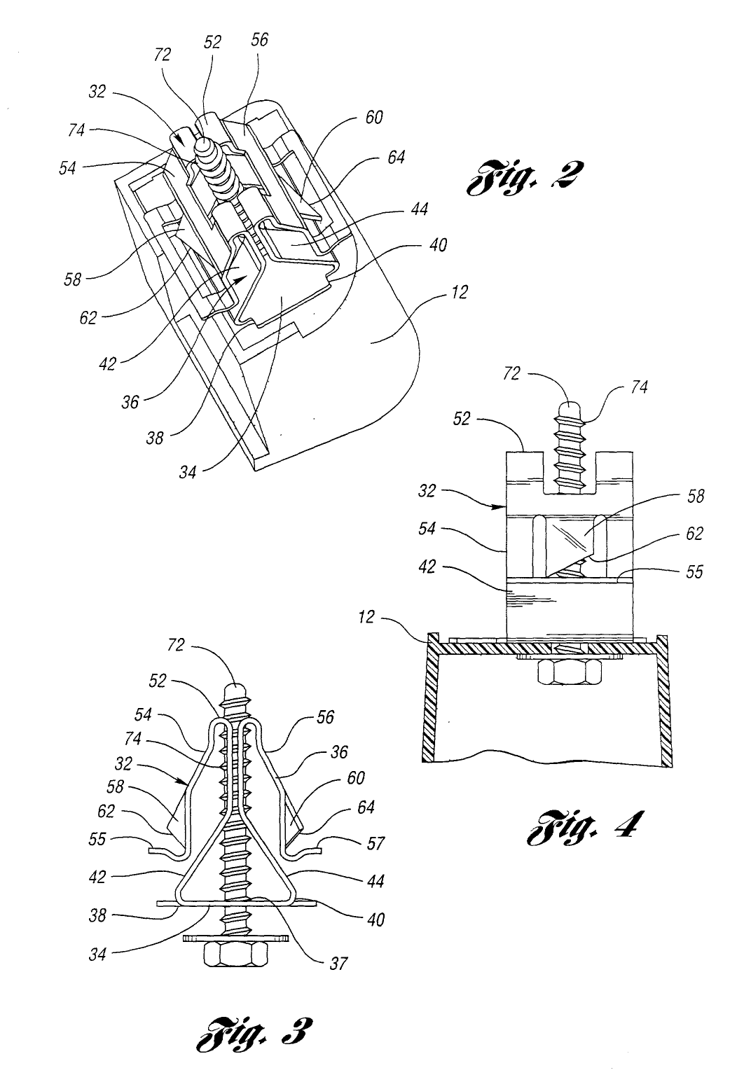

FIGS. 2 and 3 illustrate mounting fastener 32 having base member 34 and biased member 36 extending from base member 34. As shown, base member 34 has base aperture 37 formed therethrough. In this embodiment, base member 34 is substantially planar and is disposed adjacent panel member 12. Of course, base member 34 may be configured any other suitable way to attach onto panel member 12. Base member 34 further includes first and second opposing ends 38, 40. Mounting fastener may be made of any suitable rigid material such as metal.

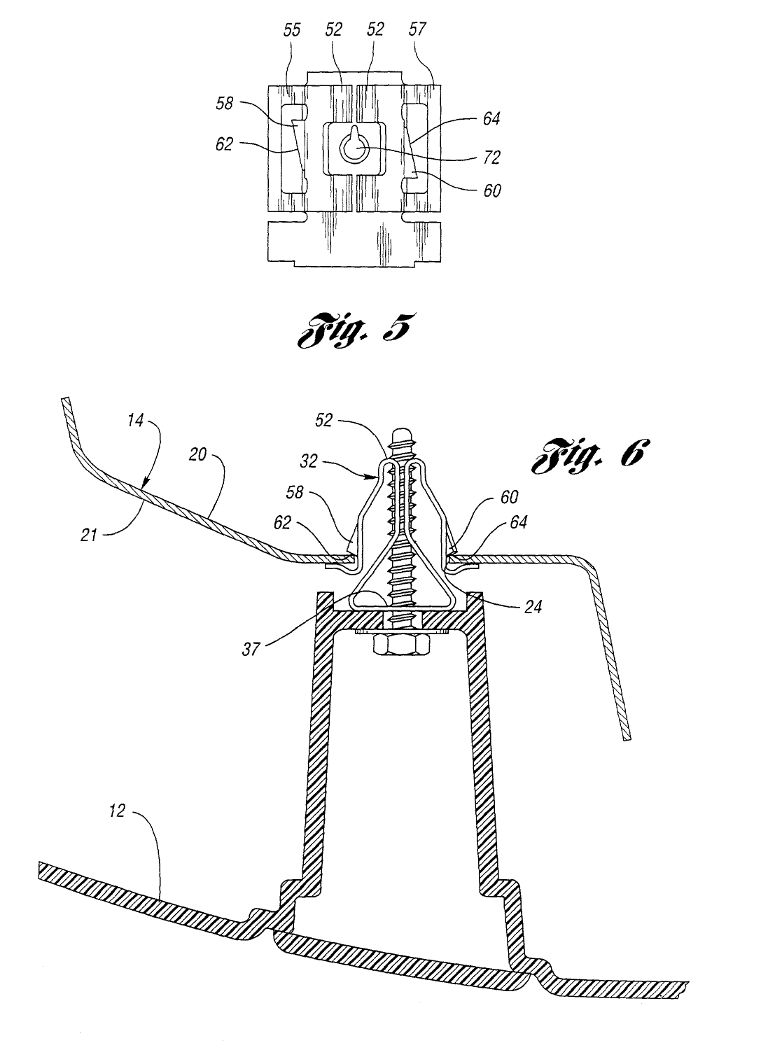

As shown in FIGS. 2-4, mounting fastener 32 further includes biased member 36 having first and second legs 42, 44 respectively extending from first and second ends 38, 40 of base member 34. From first and second ends 38, 40, legs 42, 44 extend therefrom and merge together into a substantially parallel relationship to a head 52. In this embodiment, legs 42, 44 respectively extend inwardly from ends 38, 40 to converge substantially midway to head 52, and then extend in substantially parallel relationship upwardly therefrom to head 52. However, legs 42, 44 may be configured to merge in any other suitable fashion. Moreover, the head 52 has first and second wings 54, 56 which respectively extend from first and second legs 42, 44 toward base member 34. As shown, wings 54, 56 respectively have flaps 58, 60 which extend therefrom. In this embodiment, each of flaps 58, 60 is formed substantially at the center of each respective wing. Of course, flaps 58, 60 may be formed off-center of the wing without departing from the scope or spirit of the present invention. As shown in FIGS. 3 and 4, each of the flaps is twisted with respect to the respective wing and extends outwardly to a distal edge 62, 64. Each of the distal edges 62, 64 forms an acute angle with respect to the respective wing. Distal edges 62, 64 are configured to engage an inside surface of a vehicle support structure when mounting fastener 32 is inserted through a hole of the support structure to attach panel member 12 to the support structure. Edges 62, 64 are configured to engage, with improved leverage, onto the inside surface of support 14 such that fastener 32 is retained in the hole of support structure 14 in an improved fashion to thereby anchor panel member 12 onto support structure 14.

Wings 54, 56 respectively extend to first and second flanges 55, 57 which project orthogonally therefrom. Flanges 55, 57 are configured to engage outside surface 21 of support structure 14 when head 52 of biased member 36 is inserted through the mounting hole 24 for attachment of panel member 12 to support structure 14. Base aperture 37 will be in alignment with mounting hole 24 of panel member 12 when mounting fastener 32 is attached to panel member 12.

As shown in FIGS. 3-5, mounting fastener 32 is attached to panel member 12 by way of second fastener 72. As shown, second fastener 72 is a threaded fastener, e.g., a screw, having threads 74 which facilitate the attachment of mounting fastener 32 to panel member 12. As shown in FIG. 6, second fastener 72 is configured to be disposed through mounting hole 24 and base aperture 37 to attach mounting fastener 32 to panel 12. In this embodiment, second fastener 72 is threaded through mounting hole 24 and base aperture 37.

As shown in FIG. 6, each of the distal edges 62, 64 engages inside surface 20 of support structure 14 when head 52 of biased member 36 is inserted through mounting hole 24 for attachment of panel member 12 to support structure 14. Retention of panel member 12 to support structure 14 is attained during deployment of an air bag by engagement of first and second distal edges 62, 64 onto inside surface 20 and engagement of first and second flanges 55, 57 onto outside surface 21 of support structure 14. Second fastener 72 is threaded through mounting hole 24 and base aperture 37 to facilitate retention of mounting fastener 32 onto panel member 12.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A mounting fastener attachable to a panel member of a vehicle for retention of the panel member to a support structure, the support structure having inside and outside surfaces and a mounting hole formed through the support structure, the mounting fastener comprising:
a base member having first and second opposing ends, the base member being substantially planar for attachment to the panel member;
a biased member having first and second legs respectively extending from the first and second ends and merging together into a substantially parallel relationship at a head, the head having first and second wings respectively extending from the first and second legs toward the base member, each wing having a flap which is twisted with respect to the wing and extends outwardly to a distal edge, the distal edge forming an acute angle with respect to the wing and is configured to engage the inside surface of the support structure when the head of the biased member is inserted through the mounting hole for attachment of the panel member to the support structure.

2. The mounting fastener of claim 1 wherein each wing extends to a flange projecting orthogonally therefrom, the flange configured to engage the outside surface of the support structure when the head of the biased member is inserted through the mounting hole for attachment of the panel member to the support structure.

3. The mounting fastener of claim 1 wherein the base member further includes a base aperture being in alignment with the mounting hole of the panel member when the mounting fastener is attached thereto.

4. The mounting fastener of claim 3 further comprising a second fastener disposed through the mounting and base apertures to attach the mounting fastener to the panel member.

5. The mounting fastener of claim 4 wherein the second fastener is a threaded member which is threaded through the mounting and base apertures.

6. A mounting fastener attached to a panel member of a vehicle for retention of the panel member to a support structure, the support structure having inside and outside surfaces and a mounting hole formed through the support structure, the mounting fastener comprising:
a base member having first and second opposing ends, the base member being substantially planar for attachment to the panel member;
a biased member having first and second legs respectively extending outwardly from the first and second ends and converging to extend in substantially parallel relationship to a head, the head having first and second wings respectively extending from the first and second legs toward the base member, each wing having a flap which is configured to twist with respect to the wing and extend outwardly to a distal edge, the distal edge forming an acute angle with respect to the wing and configured to engage the inside surface of the support structure when the head of the biased member is inserted through the mounting hole for attachment of the panel member to the support structure, each wing extending to a flange projecting outwardly therefrom, the flange being configured to engage the outside surface of the support structure when the distal edge engages the inside surface of the support structure.

7. The mounting fastener of claim 6 wherein the edge of the flap has a portion which is configured to engage the inside surface of the support structure when the head of the biased member is disposed through the mounting hole for attachment of the panel member to the support structure.

8. The mounting fastener of claim 6 wherein the bottom member further includes a bottom aperture being in alignment with the mounting hole of the panel member when the mounting fastener is attached thereto.

9. The mounting fastener of claim 8 further comprising a second fastener disposed through the mounting and bottom apertures to attach the mounting fastener to the panel member.

10. The mounting fastener of claim 9 wherein the second fastener is a threaded member which is threaded through the mounting and bottom apertures.

11. A mounting assembly of a panel member of a vehicle for retention of the panel member to a support structure, the panel member having a panel aperture formed therethrough and an inner side to which an air bag is disposed for deployment during an impact of the vehicle, the inner side being disposed adjacent the support structure, the support structure having inside and outside surfaces and a mounting hole formed through the support structure, the assembly comprising:
a first mounting fastener having a base member and a biased member, the base member having first and second opposing ends, the base member being substantially planar for attachment to the panel member, the biased member having first and second legs respectively extending from the first and second ends and converging to extend in substantially parallel relationship to a head, the head having first and second wings respectively extending from the first and second legs toward the base member, each wing having a flap which is twisted with respect to the wing and extends outwardly to a distal edge, the distal edge forming an acute angle with respect to the wing and is configured to engage the inside surface of the support structure when the head of the biased member is inserted through the mounting hole for attachment of the panel member to the support structure, the base member having a base aperture being in alignment with the mounting hole of the panel member when the first mounting fastener is attached to the panel member; and
a second mounting fastener disposed through the panel aperture and the base aperture to attach the first mounting fastener to the inner side of the panel member.

12. The mounting assembly of claim 11 wherein the second mounting fastener is a threaded elongated member which is threaded through the panel and bottom apertures to attach the first mounting fastener to the inner surface of the panel member.
